(19) United States
(12) Patent Application Publication
(10) Pub. No.: US 2011/0183736 A1
(43) Pub. Date: Jul. 28, 2011

(54) GAMING SYSTEM AND A METHOD OF GAMING

(76) Inventors: Christopher Michael Stevens, Lane Cove NSW (AU); Martin Kenneth Leach, Vaucluse NSW (AU)

(21) Appl. No.: 13/079,960

(22) Filed: Apr. 5, 2011

Related U.S. Application Data
(63) Continuation of application No. 11/936,626, filed on Nov. 7, 2007, now abandoned.

(30) Foreign Application Priority Data
Nov. 13, 2006 (AU) 2006906331

(51) Int. Cl. A63F 13/00; A63F 9/24

(52) U.S. Cl. 463/9; 463/42

(57) ABSTRACT

A gaming system comprising a clue entitlement mechanism arranged to determine based at least partly on a player's game play activity in respect of at least one primary game whether the player is entitled to a clue intended to assist the player in playing of a game, and a clue issuer arranged to issue a clue to a player entitled to a clue.

### RELATED APPLICATIONS

This application is a continuation of co-pending U.S. application Ser. No. 11/936,626, filed Nov. 7, 2007 and is related to and claims priority from, Australian Patent Application No. 2006906331, filed on Nov. 13, 2006, entitled “Gaming System and a Method of Gaming,”, which is herein incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a gaming system and to a method of gaming.

It is known that a player who plays a game may qualify for play of another game. In one known arrangement, one or more winning outcomes obtained by a player playing an electronic gaming machine entitles the player to enter a bonus or feature game played on the same gaming machine. It is also known from AU 2002318160 that a player playing a game on an electronic gaming machine can win the opportunity to wager on another game.

While these existing games provide some enjoyment, there is a need for an alternative gaming system.

### BRIEF SUMMARY OF THE INVENTION

In a first aspect, the invention provides a gaming system comprising:

a clue entitlement mechanism arranged to determine based at least partly on a player's game play activity in respect of at least one primary game whether the player is entitled to a clue intended to assist the player in playing of a game; and a clue issuer arranged to issue a clue to a player entitled to a clue.

In an embodiment, the clue is intended to assist the player in further play of the primary game.

In an embodiment, the clue is intended to assist the player in playing the secondary game.

In an embodiment, a gaming machine operable by the player to play the at least one primary game constitutes the clue issuer.

In an embodiment, a gaming machine operable by the player to play the at least one primary game is arranged to issue a clue entitlement to the player to enable a player to obtain a clue from the clue issuer.

In an embodiment, the gaming system is arranged to issue the clue and/or the clue entitlement in the form of data provided to the player as a message.

In an embodiment, the gaming system is arranged to issue the clue and/or the clue entitlement in the form of data provided to the player in material form.

In an embodiment, the gaming system is arranged to issue the clue and/or the clue entitlement in the form of data provided to the player by associating data with a player record on a player tracking device or in a database.

In an embodiment, the clue issuer is arranged to issue a clue in response to receipt of a clue entitlement.

In an embodiment, the clue issuer is arranged to issue the clue during play of the secondary game.

In an embodiment, a gaming machine operable by the player to play the at least one secondary game constitutes the clue issuer and is arranged to issue a clue in response to a clue entitlement being provided by the player.

In an embodiment the gaming system comprises a network and a plurality of gaming machines configured for play of the at least one primary game.

In an embodiment, each gaming machine provides a clue entitlement mechanism.

In an embodiment, the clue entitlement mechanism is a component in the network configured to process data obtained by a player tracking component of the network.

In an embodiment the gaming system is arranged to issue different clues based on one or more of: the primary game the player plays, the gaming machine the player plays, or the player's game play activity.

In an embodiment, the game play activity used as the basis for issuing a clue is one or more of: a game outcome, turnover, an amount bet, an amount of games played, time, or a gaming machine related event.

In an embodiment, clues are divided into categories based on the extent to which they are intended to assist a player.

In an embodiment, the clue issuer is one or more of a gaming machine in the gaming network, another component in the network or independent of the network.

In a second aspect, the invention provides a method of gaming comprising:

determining based at least partly on a player's game play activity in respect of at least one primary game whether the player is entitled to a clue intended to assist the player in playing of a game; and

issuing a clue to a player entitled to a clue.

In an embodiment, the clue is intended to assist the player in further play of the primary game.

In an embodiment, the clue is intended to assist the player in playing the secondary game.

In an embodiment, the method comprises issuing the clue and/or the clue entitlement in the form of data provided to the player as a message.

In an embodiment, the method comprises issuing the clue and/or the clue entitlement in the form of data provided to the player in material form.

In an embodiment, the method comprises issuing the clue and/or the clue entitlement by associating data with a player record on a player tracking device or in a database.

In an embodiment, the method comprises issuing the clue during play of the secondary game.

In an embodiment, the method comprises processing data obtained by a player tracking component of the network to determine a clue entitlement.

In an embodiment, the method comprises issuing different clues based on one or more of the primary game the player plays, the gaming machine the player plays, or the player's game play activity.

In an embodiment, the game play activity used as the basis for issuing a clue is one or more of: a game outcome, turnover, an amount bet, an amount of games played, time, or a gaming machine related event.

In an embodiment, clues are divided into categories based on the extent to which they are intended to assist a player, and clues are provided from a category based on the player's game play activity.

In a third aspect, the invention provides computer program code which when executed causes a computer to implement the above method.

In a fourth aspect, the invention provides a computer readable medium comprising the above program code.

In a fifth aspect, the invention provides a data signal comprising the above program code.

In a sixth aspect, the invention provides a gaming system comprising:

a piece entitlement mechanism arranged to determine based at least partly on a player's game play activity in respect of at least one primary game whether the player is entitled to a piece of a set of pieces intended to be redeemed for a prize; and

a prize issuer arranged to issue the prize when a player establishes their entitlement to the complete set of pieces.

In an embodiment, the gaming system comprises a piece issuer arranged to issue a piece to a player entitled to a piece, wherein the prize issuer is arranged to issue the prize in response to receipt of the pieces.

In an embodiment, the gaming system is arranged to issue the piece entitlement in the form of data provided to the player in material form.

In an embodiment, the gaming system is arranged to issue the piece entitlement in the foam of data provided to the player by associating data with a player record on a player tracking device or in a database.

In a seventh aspect, the invention provides a method of gaming comprising:

determining based at least partly on a player's game play activity in respect of at least one primary game whether the player is entitled to a piece of a set of pieces intended to be redeemed for a prize; and

issuing the prize when a player establishes their entitlement to the complete set of pieces.

In an embodiment, the method comprises issuing a piece to a player entitled to a piece and issuing the prize in response to receipt of the pieces.

In an eighth aspect, the invention provides computer program code which when executed causes a computer to implement the above method.

In a ninth aspect, the invention provides a computer readable medium comprising the above computer program code.

In a tenth aspect, the invention provides a data signal comprising the above computer program code.

### BRIEF DESCRIPTION OF SEVERAL VIEWS OF THE DRAWINGS

FIG. 1 is a schematic diagram of a gaming system;

FIG. 2 is a perspective view of a gaming system in the form of a stand alone gaming machine;

FIG. 3 is a schematic diagram of a gaming system;

FIG. 4 is a schematic diagram illustrating the memory of FIG. 3;

FIG. 5 is a schematic diagram of a gaming system having networked gaming machines;

FIG. 6 is a schematic diagram of a first clue issuing arrangement;

FIG. 7 is a schematic diagram of a second clue issuing arrangement;

FIG. 8 is a schematic diagram of a networked clue issuing arrangement;

FIG. 9 is a schematic diagram of a clue issuing arrangement where clue entitlements are issued on a first electronic gaming machine and redeemed during play of a secondary game on a second electronic gaming machine;

FIG. 10 shows an alternative embodiment where pieces are issued instead of clues;

FIG. 11 is a flow chart of a method according to the embodiments of FIGS. 6 to 9; and

FIG. 12 is a flow chart of a method according to the embodiment of FIG. 10.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Referring to the drawings, there is shown a gaming system where clues are issued to a player based on a player's game play activity in at least one primary game. The clues are intended to assist the player in playing of a secondary game. In an alternative embodiment, pieces of a set of pieces intended to be redeemed for a prize are issued to a player instead of clues. The gaming system can take a number of different forms.

In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

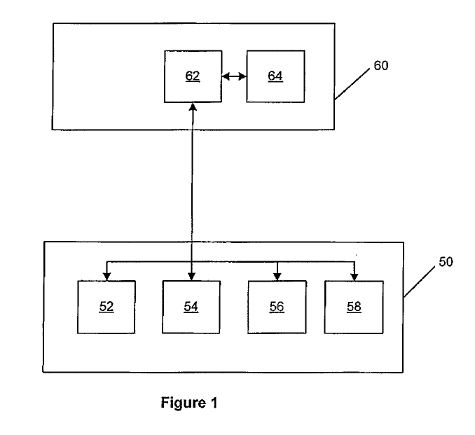

Irrespective of the form, the gaming system comprises several core components. At the broadest level, the core components are a player interface 50 and a game controller 60 as illustrated in FIG. 1. The player interface is arranged to enable interaction between a player and the gaining system and for this purpose includes the input/output components required for the player to enter instructions and play the game.

Components of the player interface may vary from embodiment to embodiment but will typically include a credit mechanism 52 to enable a player to input credits and receive payouts, one or more displays 54 and a game play mechanism 56 that enables a player to input game play instructions.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

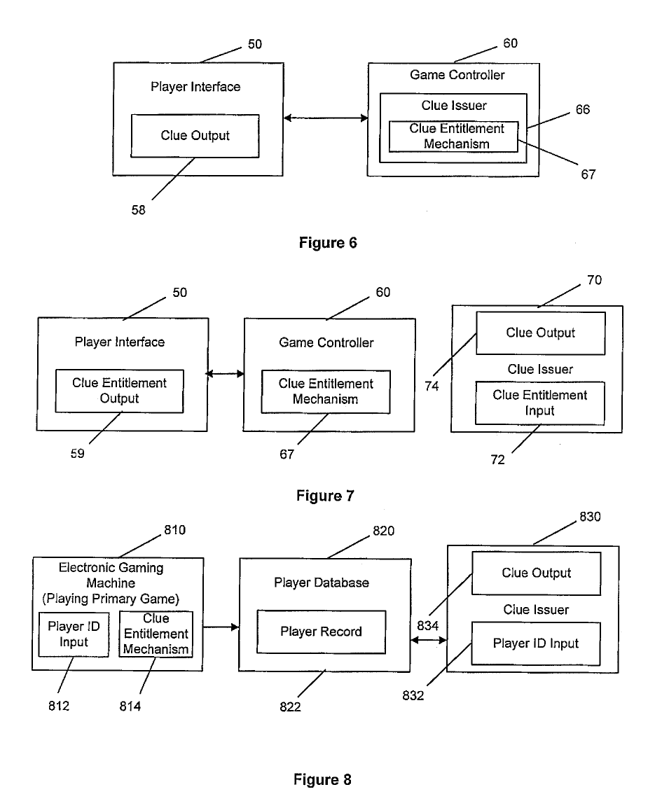

The gaming system of the embodiment includes a clue entitlement mechanism for determining whether a player is entitled to be issued a clue based on the player's game play activity in relation to at least one primary game and a clue issuer for issuing the clue to the player. Persons skilled in the art will appreciate that in some embodiments there may be a plurality of different primary games from which a player may obtain clues. Indeed, in some embodiments different clues for the same secondary game may be available from different games. Persons skilled in the art will also appreciate that the clue entitlement mechanism and clue issuer can take a number of different forms; the two main finals are illustrated in FIGS. 6 and 7.

In FIG. 6, the clue issuer 66 is a component of the game controller 60 and incorporates the clue entitlement mechanism 67. The clue entitlement mechanism monitors game play activity and determines whether a player has become entitled to a clue based on their game play activity. When the clue entitlement mechanism 67 determines that a player has become entitled to a clue, the clue issuer 66 sends a clue to the clue output mechanism 58. The clue output mechanism 58 may take a number of forms, for example, a display for displaying a message, a ticket issuer, or a write mechanism for writing data to a player tracking device.

The other main form of a gaming system including a clue issuer 70 is illustrated in FIG. 7. In this fowl, the clue issuer 70 is provided as a separate component to the clue entitlement mechanism 67. In this embodiment, clue entitlement mechanism 67 determines whether a player is entitled to a clue and, if it does, it controls clue entitlement output 59 to output a clue entitlement to the player in the form of a message, a ticket, data to a player tracking device, etc. The player then subsequently retrieves the clue by providing the clue entitlement to a clue entitlement input 72 of a clue issuer 70. The clue issuer 70 incorporates a clue output mechanism 74 for outputting the clue to a player as described in relation to FIG. 6, the clue output mechanism 74 may be a display, a printer or configured to output data sent to the player's player tracking device. In an embodiment, as described in further detail below, the clue issuer 70 may form part of a gaming machine arranged to play the secondary game and it may issue clues during play of the secondary game.

The game play activity used as the basis of determining the entitlement can be, for example, turnover on the gaming machine, the outcome of a game or a feature game, time, a machine related event, or an event related to a system to which the machine is connected. Persons skilled in the art will appreciate that the clue entitlement mechanism will be configured to respond to the relevant game play activity. For example, in the case of turnover, the clue entitlement mechanism 67 may incorporate a meter for monitoring turnover and issuing of a clue entitlement based on a threshold being passed. Similarly, if time is measured, the clue entitlement mechanism 67 may incorporate a timer for monitoring expired time.

As described above, a clue can be delivered to a player by one of many methods, including but not limited to a ticket printed by the gaming machine, a message on the machine, a message on a piece of auxiliary equipment, a ticket issued by an attendant or issued onto a player card and redeemed at a player information terminal, or issued on a player tracking device, or redeemed during playing of another game.

The delivery method may be adapted to suit the needs of the player, the regulators and the market in which the gaming system is deployed.

As in the example given in FIG. 7, the clue entitlement can be issued separately. For example, in the form of a message to “Call Mr Cashman on *** and use your PIN number ### to redeem your clue” or “Log into our website and use your PIN number ### to redeem your clue.”. Clues can also be delivered in other ways, for example by mail or messenger.

In any embodiment where there is an interim step between determining that the player is entitled to a clue and redeeming of a clue, this is referred to as a clue entitlement. A clue entitlement can be issued by a machine that is then subsequently redeemed by a clue issuer. The clues obtained from the clue issuer will typically be downloaded to the clue issuing machine over a network. For example a PIN number can be correlated to a specific clue held in the database.

Alternatively, the clues are programmed into the game code software run on the gamin. g machine and released at times to suit play of the secondary game. For example, a primary game can be designed to generate a set of different clue entitlements corresponding to different clues that may be released by a secondary game. A plurality of clue entitlements can be stored on a player tracking device. The player supplies the player tracking device to a gaming machine when playing the secondary game and clues are supplied to the player at appropriate times during play of secondary game on the electronic gaming machine based on the entitlements stored in the player tracking device. Persons skilled in the art will appreciate that the primary and secondary games could be played on the same gaming machine. That is, in some gaming systems, gaming machines are configured to allow a player to select which game they play on a particular gaming machine. Alternatively, the secondary game could be a bonus or feature game.

The clue will be of the nature to enable the player to use the clue in the play of the secondary game. Preferably the chance of winning the secondary game is enhanced by having large numbers of different clues. Once the secondary game is concluded, the previously issued clues will be redundant and a new set of clues that are required will become available.

In some embodiments, the clues can be categorised into different classes of clues. Different classes of clues can be found, for example in different types of machines or can be available from different games. For example, clues can be in the categories of time, place or person and the time clues are found on $1 machines, place clues are found on 10 c machines and person clues are found on 10 c machines.

In the embodiment, clues can only be used to play the secondary game. Ideally the secondary game is a game which requires the player to use the clues acquired from the play of the primary game. Preferably, the clues are designed such that the player with the most clues will have a better chance of solving the special game and winning. Alternatively, some clues will have more “value” than others and the player with the more favourable clues will have more chance of solving the second game.

In another embodiment, the clues can provide a key or information to a player which enables the player to enter a special feature or play a special game which has an enhanced player return.

In another embodiment, the player receives clues from a gaming machine or preferably many gaming machines which, with all clues in hand, can lead the player to some destination. At this destination, a “hidden treasure” can be retrieved which can subsequently be redeemed. By way of example, clues may direct the player to a location, provide an instruction or a limit.

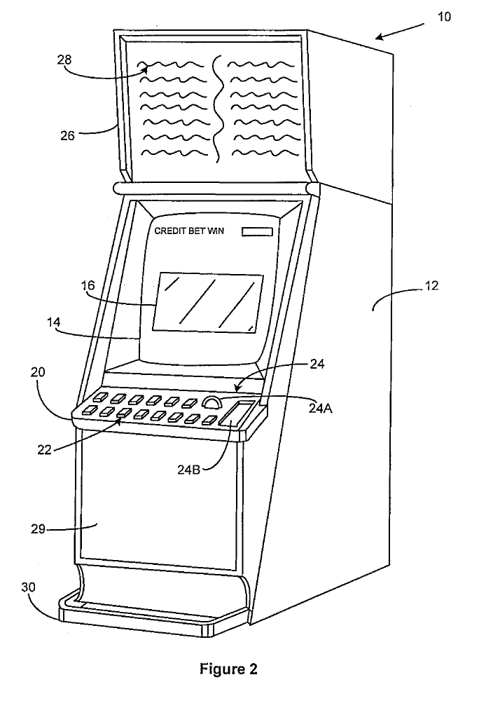

A gaming system in the form of a stand alone gaming machine 10 is illustrated in FIG. 2. The gaming machine 10 includes a console 12 having a display 14 on which are displayed representations of a game 16 that can be played by a player. Depending on the embodiment, display 14 may also be used to output clues or clue entitlements. A mid-trim 20 of the gaming machine 10 houses a bank of buttons 22 for enabling a player to interact with the gaming machine, in particular during game play and thus provide a game play mechanism. The mid-trim 20 also houses a credit input mechanism 24 which in this example includes a coin input chute 24A and a bill collector 24B. Other credit input mechanisms may also be employed, for example, a card reader for reading a smart card, debit card or credit card. A read/write device (not shown) may also be provided for the purpose of reading and writing a player tracking device, for example as part of a loyalty program or if clues or clue entitlements are to be issued to the player tracking device. The player tracking device may be in the Ruin of a card, flash drive or any other portable storage medium capable of being read by the reading device. The player tracking device reader may be provided in player marketing module connected to the gaming machine and adapted to communicate with the gaming machine.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type. In some embodiments, clues or clue entitlements may be displayed on a top box video display.

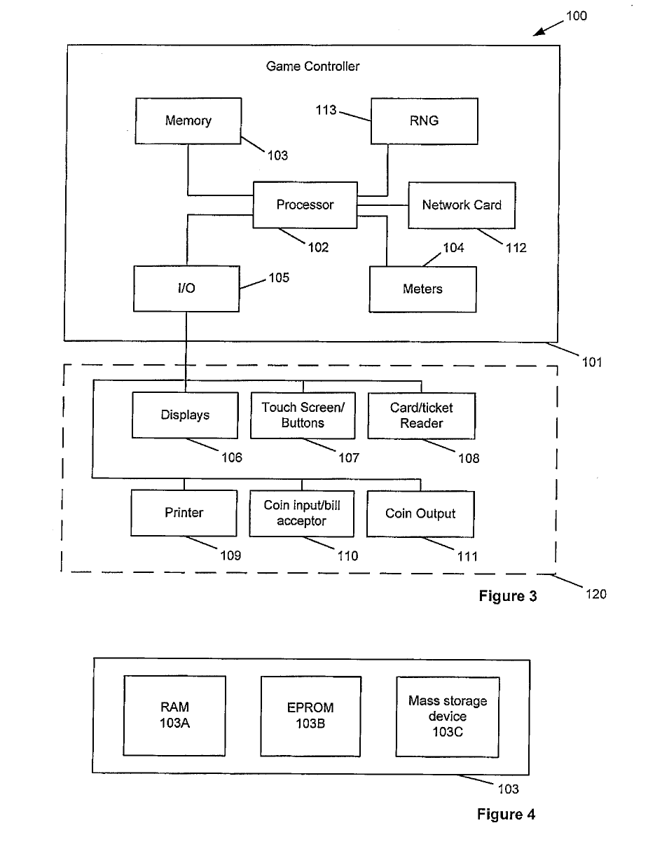

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. A subset of the instructions and data will relate to implementation of the game. The clue entitlement mechanism and clue issuer may be implemented as another subset of the instructions implemented by the processor. Alternatively, separate hardware may be provided for issue clues and/or clue entitlements. For example, a circuit that monitors meters 104. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 comprise one or more displays 106, a touch screen and/or buttons 107, a card and/or ticket reader 108, a printer 109, a bill acceptor and/or coin input mechanism 110 and a coin output mechanism 111. In some embodiments, ticket reader 108 may read clue entitlement tickets and printer 109 may print clues or clue entitlements. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 1038 or elsewhere.

It is also possible for the operative components of the gaming machine 100 to be distributed, for example input/output devices 106,107,108,109,110,111 to be provided remotely from the game controller 101.

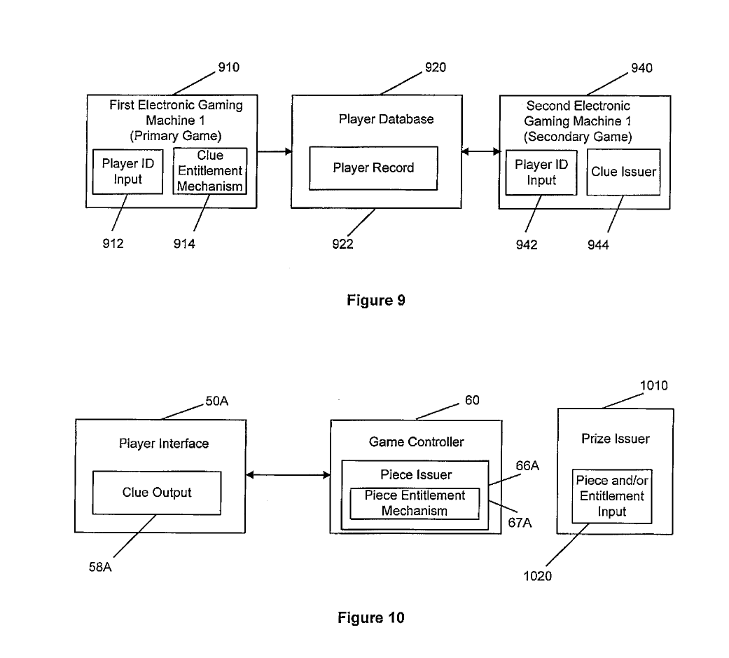

FIGS. 8 and 9 show two possible implementations of a clue issuer and clue entitlement mechanism in a networked gaming environment. In FIG. 8, an electronic gaming machine 810 is used by a player to play a primary game, noting that there may be a plurality of eligible primary games from which clues are distributed. In order to obtain clues, the player enters a player ID using player ID input 812 of the electronic gaming machine 810. It is envisaged that the player ID input would typically be a player tracking device reader of the gaming machine (or connected to the gaming machine) so that the player ID would be provided by supplying a player tracking device to the tracking device reader but it could also be a keypad, touch screen or the like. The gaming machine 810 includes a clue entitlement mechanism 814 that determines that the player is entitled to a clue in the general manner described above. When the player is entitled to a clue the clue entitlement mechanism communicates the clue entitlement to a player database where it is a stored in a player record 822 of a player database 820 containing a series of player records. A player may at some later time provide their player ID to clue issuer, for example in the fowl of a kiosk specially designed to issue clues. The clue issuer 830, examines the player record 822 for the player corresponding to the player ID input using the player ID input 832, determines what clues the player is entitled to based on the clue entitlements stored in the player record and outputs the clues using clue output mechanism 834. The clue output mechanism 834 can be in any of the forms described above including a ticket printer.

In the alternative arrangement of FIG. 9, the player uses a first electronic gaming machine 910 to play a primary game. Before playing the primary game, the player inputs their player ID using player ID input 912 in the manner described above. During play of the primary game, the electronic gaming machine 910 determines whether the player is entitled to a clue entitlement 914 and sends entitlement data to the player database which updates the player record 922.

In this embodiment, clues are issued to a player during play of a secondary game on a second electronic gaming machine 940 arranged for play of the secondary game. Prior to playing the game, the player enters their ID using ID input 942, and clue issuer 944 determines based on the ID whether their associated player record 922 contains any clue entitlements required for the secondary game. The clue issuer 914 issues clues on the basis of the player's clue entitlement during appropriate parts of play of the secondary game.

It will be appreciated that in such networked embodiments, the player database may be implemented as part of an existing loyalty program. At least in this embodiment, the clue entitlement may be combined with the player reward program. For example, if a player obtains a series of rewards based on turnover, these rewards may be redeemable for clues for use in the secondary game. In this embodiment, the clue issuer is typically configured to allow the player to selectively redeem rewards for clues. In at least this embodiment, things other than game play that contribute to reward entitlements may thus contribute to clue entitlements, for example other purchases made at a gaming venue.

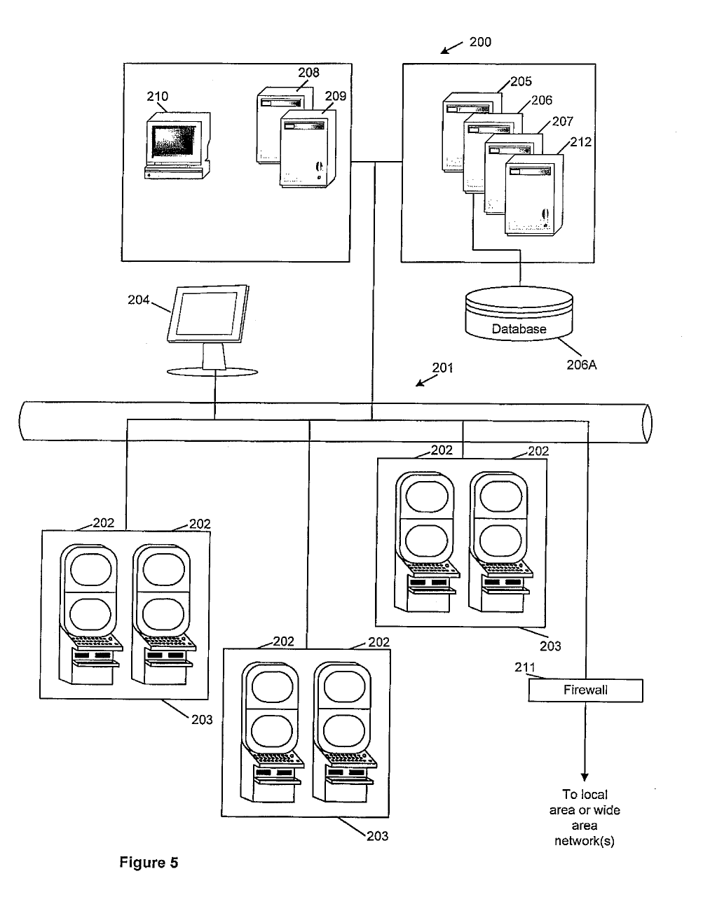

FIG. 5 shows more detail of a gaming system 200 that includes a network 201, which for example may be an Ethernet network. Gaming machines 202, shown arranged in three banks 203 of two gaining machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming machine implement part of the game, they collectively provide a game controller. Thus, depending on the embodiment, the clue issuer or clue entitlement mechanism could be provided on the gaming machine or the game server or a combination thereof. A database management server 206 may manage storage of game programs and associated data for downloading or access by the gaming devices 202 in a database 206A. Typically, if the gaming system 200 enables players to participate in a Jackpot game, a Jackpot server 207 will be provided to monitor and carry out accounting functions for the Jackpot game.

In a thin client embodiment, game server 205 implements most or all of the game played by a player using a gaming machine 202 and the gaming machine 202 essentially provides only the player interface. With this embodiment, the game server 205 provides the game controller. Hence, the clue entitlement mechanism and/or clue issuer would typically be provided by the server with the gaming machine merely acting to output the clue or clue entitlements. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming system 200, including for example a gaming floor management server 208, and a licensing server 209 to monitor the use of licenses relating to particular games. An administrator terminal 210 is provided to allow an administrator to run the network 201 and the devices connected to the network. Server 212 may implement a player rewards program where reward data is collected against a record identifying the player. As described above, clue entitlements may be stored in, and retrieved from, the player's player record.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games as required by the terminals.

FIG. 10 shows a variation on the above embodiments. In this embodiment, rather than clues being issued, a series of “pieces” are issued. Thus, instead of a clue issuer, the system includes a piece issuer and a piece entitlement mechanism 66A, 67A and a piece output mechanism 58A. The technique for deciding when to issue a piece operates substantially as described above in relation to clues. In this alternative, a player attempts to collect all pieces of a set and when they do so they can redeem the set for a prize. In some embodiments, this will fowl a secondary game, for example where the secondary game is to be the first person to redeem the set. In some embodiment, the player's establishment of an entitlement to all the pieces will be sufficient and accordingly, depending on the embodiment, the input 1020 to prize issuer 1010 may be a piece and/or entitlement—i.e. the player will not have to provide the pieces in some embodiments.

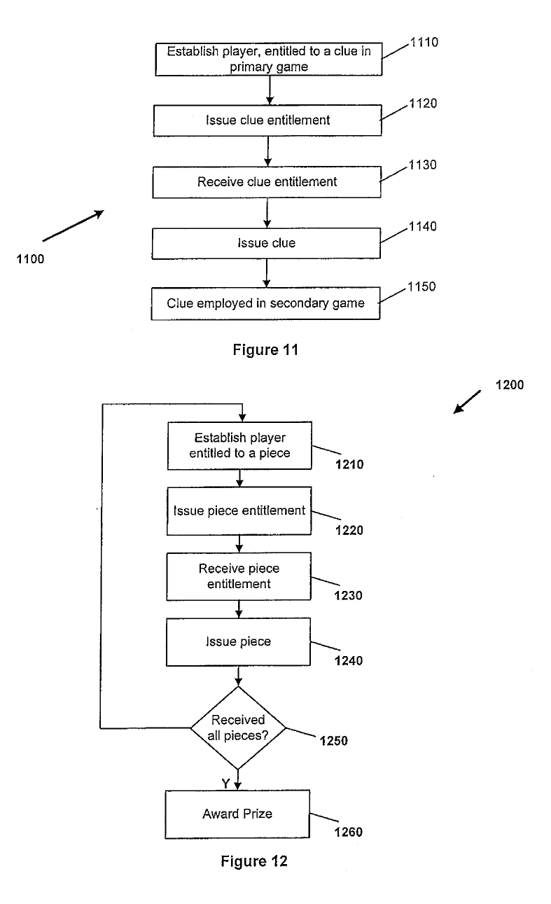

The method of the first embodiment is summarised in FIG. 11. The method 1100 involves establishing that a player is entitled to a clue in a primary game 1110, issuing a clue entitlement 1120, receiving the clue entitlement 1130 and issuing a clue 1140 which then can be employed in the secondary game 1150.

The method of the alternative embodiment is summarised in FIG. 12. The method 1200 involves establishing that a player is entitled to a piece 1210, issuing a piece entitlement 1220, receiving a piece entitlement 1230, issuing the piece 1240, determining whether all pieces have been received and if so awarding the prize and if not returning to step 1210.

Persons skilled in the art will appreciate that the above functions, such as the clue issue entitlement mechanism and the clue issuer can be embodied, for example, in part, by program code executed by processor 60. Persons skilled in the art will appreciate that such program code can be supplied in a number of forms, for example, on a computer readable medium such as a disk or a memory or as a data signal which can be downloaded.

In an alternative embodiment, the clues or clue entitlement are issued in response to play in the primary game for subsequent use during later play of the primary game.

### Example 1

### Great American Treasure Hunt (OATH)

This is a version of the game, where the clues are used to solve a puzzle in a special secondary game.

The special games are played at regular intervals—in this example one per week.

A special game features a treasure hunt, where the players with a predetermined number of clues are required to find the treasure using the information provided in the clues.

Players acquire the clues by playing clearly identified OATH machines in the week preceding the special game. The clues are downloaded each week to equipment attached to the OATH machines.

In the course of playing the OATH machines, tickets are issued to players which include a printed image or message of a clue and a date on which the ticket was issued.

A Master of Ceremonies will conduct the special game. Players prove their entitlement to play the special game by showing sufficient of their tickets to the master of ceremonies to prove their entitlement. When the master of ceremonies announces the commencement of the game, the entitled players play the treasure hunt game and use their clues to try to find the treasure.

After a period of time, the master of ceremonies declares the treasure hunt completed and players are awarded prizes according to the treasure which they have found.

There can be a number of variations, for example:

Small time event—players play machines, get clues, use the clues to solve a problem (e.g. a treasure hunt) win a prize. All this can happen in one night. This can happen at a different machine or at a Board and this can be run by a Master of Ceremonies.

Bigger event—players play machines, get clues, at a special time—e.g. once per week, they use their clues to solve a problem. A Master of Ceremonies can oversight this. The problem can be solved at a machine or independent of a machine.

Bigger event—same as above, but players who reach a certain standard in round one, once per week are invited to participate in a bigger event once per month. Once again, a Master of Ceremonies can oversight.

Biggest event—same as above, but played say once per year. Entry to the event comes from success in the prior rounds (so you are earning your way up the success ladder or we can market it as a platinum level player). All players gather at a location and use their clues to hunt the grounds with their spades etc. to find the treasure. This event is run by a Master of Ceremonies

### Example 2

### Matilda

In this implementation of the game, players aim to solve a puzzle on an electronic gaming machine.

Players play machines and are awarded tickets. The tickets can only be used in a Matilda machine. When players play the Matilda machine, the machine will reveal clues as to the location of treasure. The Matilda machine will have a series of feature games where the player is required to make selections. The correct selections can be made by using the clues. The ultimate prize is awarded by making all the correct selections. Prizes can be awarded for making some correct selections.

### Example 3

### Aristocrat Web Game

In this implementation, the players aim to solve a puzzle over the internet.

Players play machines and are awarded clues. These clues can be used in a game accessible via the internet. In the internet game, the player is asked to solve a number of puzzles which are correctly solved using the clues.

### Example 4

### Happy Families

In this implementation of the game, players aim to collect a complete set of information.

Players play machines which are clearly identified as Happy Family machines and in the course of play, they are issued with tickets which indicate a member of a family such as Mr Baker or Miss Nurse. When a player has collected a complete set of a family such as Mr Baker, Mrs Baker, Master Baker and Miss Baker, the player can redeem the set for a prize. The prize can be the right to enter a special game or a non-cash prize or a cash prize.

The chance of issuing a ticket with a particular character on it is determined by a probability table to ensure that a range of prizes is available with different probabilities.

In this case, it is not necessary to hold a special event to play for a prize. Neither is it necessary to change the tickets being issued to coincide with the special event.

1. A gaming system comprising:
a clue entitlement mechanism arranged to determine based at least partly on a player's game play activity in respect of at least one primary game whether the player is entitled to a clue intended to assist the player in playing of a game; and
a clue issuer arranged to issue a clue to a player entitled to a clue.

2. A gaming system as claimed in claim 1, wherein the clue is intended to assist the player in further play of the primary game.

3. A gaming system as claimed in claim 1, the clue is intended to assist the player in playing the secondary game.

4. A gaming system as claimed in claim 1, wherein a gaming machine operable by the player to play the at least one primary game constitutes the clue issuer.

5. A gaming system as claimed in claim 1, wherein a gaming machine operable by the player to play the at least one primary game is arranged to issue a clue entitlement to the player to enable a player to obtain a clue from the clue issuer.

6. A gaming system as claimed in claim 3, wherein the clue issuer is arranged to issue the clue during play of the secondary game.

7. A gaming system as claimed in claim 6, wherein a gaming machine operable by the player to play the at least one secondary game constitutes the clue issuer and is arranged to issue a clue in response to a clue entitlement being provided by the player.

8. A gaming system as claimed in claim 1, a network and a plurality of gaming machines configured for play of the at least one primary game and each gaming machine provides a clue entitlement mechanism.

9. A gaming system as claimed in claim 8, wherein the clue entitlement mechanism is a component in the network configured to process data obtained by a player tracking component of the network.

10. A gaming system as claimed in claim 8, wherein the clue issuer is one or
more of a gaming machine in the gaming network; another component in the network or independent of the network.

11. A method of gaming comprising:
determining based at least partly on a player's game play activity in respect of at least one primary game whether the player is entitled to a clue intended to assist the player in playing of a game; and
issuing a clue to a player entitled to a clue.

12. A method of gaming as claimed in claim 11, wherein the clue is intended to assist the player in further play of the primary game.

13. A method of gaming as claimed in claim 11, wherein the clue is intended to assist the player in playing the secondary game.

14. A method as claimed in claim 13 comprising issuing the clue during play of the secondary game.

15. A method as claimed in claim 11 comprising issuing different clues based on one or more of the primary game the player plays, the gaming machine the player plays, or the player's game play activity.

16. A method as claimed in claim 11, wherein the game play activity used as the basis for issuing a clue is one or more of a game outcome, turnover, an amount bet, an amount of games played, time, or a gaming machine related event.

17. A method as claimed in claim 16, wherein clues are divided into categories based on the extent to which they are intended to assist a player, and clues are provided from a category based on the player's game play activity.

18. Computer program code which when executed causes a computer to implement the method of claim 11.

19. A gaming system comprising: a piece entitlement mechanism arranged to determine based at least
partly on a player's game play activity in respect of at least one primary game whether the player is entitled to a piece of a set of pieces intended to be redeemed for a prize; and
a prize issuer arranged to issue the prize when a player establishes their entitlement to the complete set of pieces.

20. A gaming system as claimed in claim 19 comprising a piece issuer arranged to issue a piece to a player entitled to a piece, wherein the prize issuer is arranged to issue the prize in response to receipt of the pieces.

21. A gaming system as claimed in claim 19, arranged to issue the piece entitlement in the form of data provided to the player in material fowl.

22. A gaming system as in claim 33, arranged to issue the piece entitlement in the form of data provided to the player by associating data with a player record on a player tracking device or in a database.

23. A method of gaming comprising:
determining based at least partly on a player's game play activity in respect of at least one primary game whether the player is entitled to a piece of a set of pieces intended to be redeemed for a prize; and
issuing the prize when a player establishes their entitlement to the complete set of pieces.

24. A method as claimed in claim 23 comprising issuing a piece to a player entitled to a piece and issuing the prize in response to receipt of the pieces.

25. Computer program code which when executed causes a computer to implement the method of claim 23.
